(19) United States
(12) Patent Application Publication
(10) Pub. No.: US 2019/0193738 A1
(43) Pub. Date: Jun. 27, 2019

(54) Vehicle and Control Method Thereof

(71) Applicants: Hyundai Motor Company, Seoul (KR); Kia Motors Corporation, Seoul (KR)

(72) Inventors: Youngchul Oh, Seongnam-si (KR); Haeryong Lee, Suwon-si (KR); TaeDong Oh, Suwon-si (KR); Wanjae Lee, Suwon-si (KR)

(21) Appl. No.: 15/988,179

(22) Filed: May 24, 2018

(30) Foreign Application Priority Data
Dec. 21, 2017 (KR) 10-2017-0176644

(51) Int. Cl. B60W 30/18; G08G 1/16; G05D 1/02; G08G 1/00; G06K 9/00

(52) U.S. Cl. CPC B60W 30/18163; G08G 1/167; G05D 1/0293; G08G 1/22; G08G 1/166; G05D 1/0248; G05D 1/0251; G06K 9/00805; G05D 1/0289

(57) ABSTRACT

A vehicle may include a range sensor, an image sensor, a communication device configured to transmit or receive data between vehicles, a controller configured to determine whether there is a following vehicle based on the data collected by the range sensor and the image sensor, to create a target lane when there is no following vehicle, and to determine a risk of lane change, and a driving system configured to drive the vehicle by receiving a control signal from the controller.

### CROSS-REFERENCE TO RELATED APPLICATIONS

This application claims priority to Korean Patent Application No. 10-2017-0176644, filed on Dec. 21, 2017, which application is hereby incorporated herein by reference.

### TECHNICAL FIELD

The present disclosure relates to a vehicle and control method thereof.

### BACKGROUND

Platooning refers to a plurality of vehicles being driven in line. When autonomous vehicles are driven in line, they exchange vehicle information through their communication devices and the vehicles following a lead vehicle follow a moving trajectory of the lead vehicle.

In the conventional technology of platooning, as for lane changing in the platooning, a lead vehicle should first change lanes and then following vehicles do the same in order.

In a case where vehicles form a long platoon and follow the same trajectory of the lead vehicle, if a vehicle happens to cut in the platoon, not all the vehicles in the platoon may safely change lanes.

Accordingly, a need exists for a stable lane changing method for the plurality of vehicles in a platoon.

### SUMMARY

The present disclosure provides a vehicle and control method thereof, which allows the vehicle driven in a platoon to stably change lanes.

The present disclosure also provides a vehicle and method thereof, by which when a lead vehicle of a platoon determines a situation of a lane change and sends a lane change signal, a tail vehicle that runs at the end of the platoon first performs lane changing to a target lane, enabling stable lane change of the entire vehicles in the platoon.

A vehicle according to an embodiment may comprise a range sensor configured to collect data about an object around the vehicle. An image sensor is configured to collect image data around the vehicle. A communication device is configured to transmit or receive data between vehicles. A controller is configured to, upon reception of a lane change signal from a vehicle ahead in a platoon formed by the vehicle and the vehicle ahead through the communication device, determine whether there is a following vehicle based on the data collected by the range sensor and the image sensor, to create a target lane when there is no following vehicle, and to determine a risk of lane change. A driving system is configured to drive the vehicle by receiving a control signal from the controller.

The controller may be configured to extract a moving trajectory of the platoon formed by the vehicle and the vehicle ahead, and to create a target lane based on the moving trajectory of the platoon and a lane width.

The controller may be configured to determine the risk of lane change based on whether there exists a vehicle driven on the target lane.

The controller may be configured to create a lane changing route to the target lane and to determine that there is no risk of lane change when the vehicle driven on the target lane is driven ahead outside the lane changing route.

The controller may be configured to determine that there is no risk of lane change when there is no vehicle on the lane changing route for a predetermined lane changing time limit.

The controller may be configured to send a slowdown signal to the vehicle ahead based on speed of the vehicle driven on the target lane.

The controller may be configured to send a lane change complete signal to the vehicle ahead when the lane changing is completed.

The controller may be configured to receive relative coordinates of the vehicle ahead from the range sensor periodically, to reconfigure the relative coordinates by reflecting current speeds, yaw-rate information and communication delay errors of the vehicle and the vehicle ahead, and to link the reconfigured relative coordinates to extract a moving trajectory of the platoon.

The controller may be configured to forward the lane change signal to a following vehicle when such a vehicle exists.

According to an aspect of the present invention, a control method of a vehicle may comprise collecting data about an object around the vehicle; collecting image data around the vehicle; upon reception of a lane change signal from a vehicle ahead in a platoon formed by the vehicle and the vehicle ahead, determining whether there exists a following vehicle based on image data and data about an object around the vehicle; creating a target lane when there is no following vehicle; determining a risk of lane change to the target lane; and performing lane changing to the target lane when there is no risk of lane change.

The creating of the target lane may comprise extracting a moving trajectory of the platoon formed by the vehicle and the vehicle ahead; and creating a target lane based on the moving trajectory of the platoon and lane width.

The determining of the risk of lane change may comprise determining the risk of lane change based on whether there exists a vehicle driven on the target lane.

The control method of a vehicle may further comprise creating a lane changing route to the target lane, wherein the determining of the risk of lane change may comprise determining that there is no risk of lane change when the vehicle driven on the target lane is driven ahead outside the lane changing route.

The determining of the risk of lane change may comprise determining that there is no risk of lane change when there is no vehicle on the lane changing route for a predetermined lane changing time limit.

The control method of a vehicle may further comprise sending a slowdown signal to the vehicle ahead based on speed of the vehicle driven on the target lane.

The control method of a vehicle may further comprise sending a lane change complete signal to the vehicle ahead when the lane changing is completed.

The extracting of the moving trajectory of the platoon may comprise periodically receiving relative coordinates of the vehicle ahead; reconfiguring the relative coordinates by reflecting current speeds, yaw-rate information and communication delay errors of the vehicle and the vehicle ahead; and linking the reconfigured relative coordinates to extract a moving trajectory of the platoon.

The determining of whether there exists a following vehicle may comprise forwarding the lane change signal to a following vehicle when there exists the following vehicle.

According to another aspect of the present invention, a control method of vehicles driven in a platoon may comprise collecting, by a plurality of vehicles that form a platoon, platoon information and information about nearby objects; determining, by a lead vehicle in the platoon, a situation to change lanes based on the information about the nearby objects and sending a lane change signal to a following vehicle in the platoon; determining, by the following vehicle, whether the following vehicle corresponds to a tail vehicle in the platoon; creating, by the following vehicle, a target lane when the following vehicle corresponds to the tail vehicle in the platoon; determining, by the following vehicle, a risk of lane change to the target lane; and performing, by the following vehicle, lane changing to the target lane when there is no risk of lane change.

The control method of vehicles may further comprise sending, by the following vehicle, a lane change completion signal to the lead vehicle after changing lanes; and performing, by the lead vehicle, lane changing to the target lane.

The control method of vehicles may further comprise when there exists an intermediate vehicle between the lead vehicle and the following vehicle, changing, by the intermediate vehicle, lanes by following a lane changing route of the lead vehicle after the lead vehicle changes lanes.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 shows the exterior of a vehicle, according to an embodiment of the present disclosure;

FIG. 2 shows internal features of a vehicle, according to an embodiment of the present disclosure;

FIG. 3 is a control block diagram of a vehicle, according to an embodiment of the present disclosure;

FIGS. 4 and 5 are views for explaining how a vehicle changes lanes, according to an embodiment of the present disclosure;

FIG. 6 is a view for explaining a lane changing method in a case where there exists another vehicle in a target lane to which a vehicle is to move, according to an embodiment of the present disclosure;

FIG. 7 is a view for explaining how a vehicle creates a target lane, according to an embodiment of the present disclosure;

FIG. 8 is a view for explaining how a vehicle forms a lane changing route, according to an embodiment of the present disclosure;

FIG. 9 is a flowchart illustrating a control method of a vehicle, according to an embodiment of the present disclosure;

FIG. 10 is a flowchart illustrating how to control a lead vehicle in a method for controlling vehicles driven in a platoon, according to an embodiment of the present disclosure;

FIG. 11 is a flowchart illustrating how to control an intermediate vehicle in a method for controlling vehicles driven in a platoon, according to an embodiment of the present disclosure; and

FIG. 12 is a view for explaining how a vehicle driven in a platoon changes lanes, according to another embodiment of the present disclosure.

### DETAILED DESCRIPTION OF ILLUSTRATIVE EMBODIMENTS

Like numerals refer to like elements throughout the specification. Not all elements of embodiments of the present disclosure will be described, and description of what are commonly known in the art or what overlap each other in the embodiments will be omitted. The terms as used throughout the specification, such as “˜ part”, “˜ module”, “˜ member”, “˜ block”, etc., may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are just used for convenience of explanation, but not to limit an order of the steps. Thus, unless the context clearly dictates otherwise, the written order may be practiced otherwise.

The principle and embodiments of the present invention will now be described with reference to accompanying drawings.

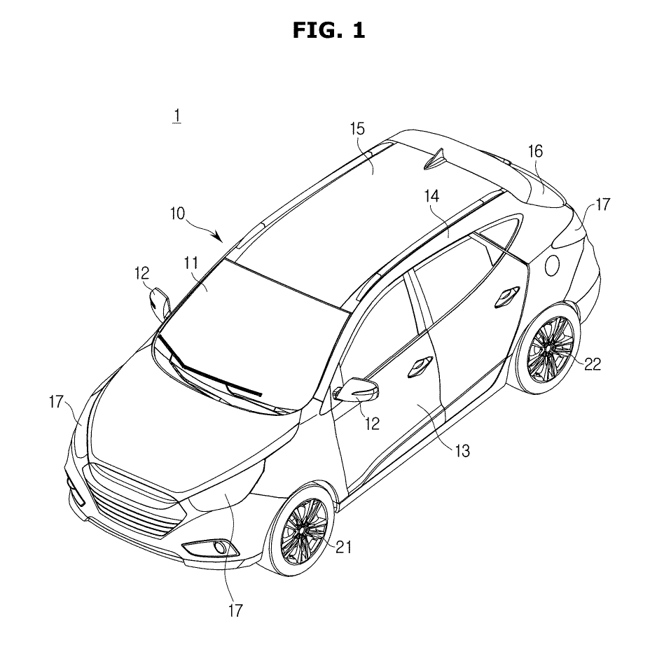

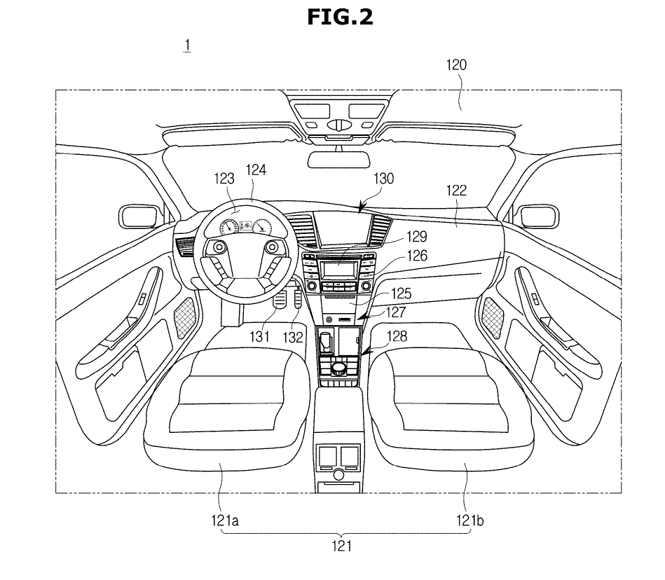

FIG. 1 shows the exterior of a vehicle, according to an embodiment of the present disclosure, and FIG. 2 shows the interior of a vehicle, according to an embodiment of the present disclosure.

Referring to FIG. 1, the exterior of a vehicle 1 may include a main body to that constitutes the exterior of the vehicle 1, a windscreen 11 for providing views ahead of the vehicle 1 for the driver, side mirrors 12 for helping the driver see views behind the vehicle 1, doors 13 for shielding the interior of the vehicle 1 from outside, fillers 14 for supporting a roof panel 15, the roof panel 15, a rear window glass 16, turn indicator lights 17, front wheels 21 located in the front portion of the vehicle 1, and rear wheels 22 located in the rear portion of the vehicle 1, the front and rear wheels 21 and 22 being collectively called car wheels.

The windscreen 11 is mounted on the upper front of the main body 10 for allowing the driver to obtain views ahead of the vehicle 1. The side mirrors 12 include a left side mirror and a right side mirror placed on the left and right sides of the main body 10, respectively, for helping the driver obtain views behind and to the sides of the vehicle 1.

The doors 13 may be pivotally attached onto the left and right sides of the main body 10, and opened for the driver and passenger to get on or get off the vehicle 1 and closed for shielding the inside of the vehicle 1 from outside.

The vehicle 1 may further include a range sensor 300 for detecting an object located in front or back or on the side of the vehicle 1 or an image sensor 400 for capturing an image around the vehicle 1. The range sensor 300 or the image sensor 400 may be equipped in the front radiator grill or front head lamp of the vehicle 1 or may be integrated with heating wires in the back of the roof panel 15, i.e., in an upper portion of the rear window glass 16, without being limited thereto.

The range sensor 300 may be a sensor for measuring a distance to an object at regular intervals, such as a laser sensor, an infrared sensor, a radar sensor, a LiDAR sensor, etc. The range sensor 300 scans the surface of an object located within a measurement range in real time while the vehicle is moving.

The LiDAR sensor is able to detect a distance to an object, the direction, speed, temperature, material distribution and concentration property, etc., by radiating laser and detecting the laser reflected from an object. The LiDAR sensor scans the surface of the object in a way of sampling and outputs the sampled dot data.

The image sensor 400 may obtain an image of the outside of the vehicle. Especially, the image sensor 400 may obtain a ground image of a road ahead of the vehicle. The image sensor 400 may be implemented with a camera.

Referring to FIG. 2, an interior part 120 of the car body includes seats 121 (121a and 121b), a dashboard 122, an instrument panel (or cluster) 123 placed on the dashboard, containing gauges and indicators, such as a tachometer, speedometer, water temperature gauge, fuel gauge, turn signal indicator, head light indicator, warning light, seat belt warning light, odometer, gearshift position indicator, door open warning light, low fuel warning light, low oil pressure warning light, etc., a steering wheel 124 for steering control of the vehicle, and a center fascia 125 having a control pad for audio system and air conditioning (AC) and ventilation system.

The seats 121 include a driver seat 121a, a passenger seat 121b, and backseats arranged in the back of the interior of the vehicle 1.

The cluster 123 may be digitally implemented. The digitally implemented cluster displays car information and traveling information in images.

The center fascia 125 is located on the dashboard between the driver seat 121a and the passenger seat 121b, including a head unit 126 for controlling the audio system, AC and ventilation system, and seat heaters.

The head unit 126 may include a plurality of buttons for receiving commands to operate the audio system, the AC and ventilation system, and seat heating wires.

Air vents, a cigar jack, etc., may be installed on the center fascia 125 and there may be a multi-terminal 127 installed on or near the center fascia 125.

The multi-terminal 127 may be arranged to be close to the head unit 126, including a universal serial bus (USB) port and an auxiliary (AUX) terminal, and optionally an SD slot.

The vehicle 1 may further include an input unit 128 for receiving commands to operate various functions, and a display 129 for displaying information about an activated function and information input by the user.

The display 129 may employ a Light Emitting Diode (LED) panel, an Organic Light Emitting Diode (OLED) panel, a Liquid Crystal Display (LCD) panel, etc.

The input unit 128 may be arranged on the head unit 126 and center fascia 125, including at least one mechanical button, such as ON/OFF buttons for operation of various functions, buttons to change settings of various functions, etc.

The input unit 128 may send a manipulation signal of the button to an electronic control unit (ECU), a controller 50 in the head unit 126 or an Audio Video and Navigation (AVN) system 130.

The input unit 128 may include a touch panel incorporated into the display of the AVN system 130. The input unit 128 may be activated and displayed on the display of the AVN system 130 in the form of at least one button, and receive information of the location of the button.

It is also possible that the input unit 128 includes a jog dial (not shown) or a touch pad for the user to input an instruction to move or select a cursor displayed on the display of the AVN system 130. The jog dial or touch pad may be arranged on the center fascia 125.

Specifically, the input unit 128 may receive a selection of passive driving mode in which the driver drives the vehicle by him/herself and autonomous driving mode, and once a selection of the autonomous driving mode is received, send an input signal of the autonomous driving mode to the controller 500.

The controller 500 may send control signals to the respective devices in the vehicle 1 as well as serve to distribute signals to the devices in the vehicle 1. The term ‘controller’ is used in a broad sense and may be called differently without being limited.

Furthermore, once the GPS function is selected, the input unit 128 may receive and forward destination information to the AVN system 130, and once the DMB function is selected, it may receive and forward channel and volume information to the AVN system 130.

The AVN system 130 may be arranged on the center fascia 125 for receiving information from the user and outputting results corresponding to the input information.

The AVN system 130 may perform at least one of GPS, DMB, audio, and video functions, and display road condition information, traveling information, and the like while in the autonomous driving mode. The AVN system 130 may even be detachably installed on the dashboard.

The chassis of the vehicle further includes a power generating system, a power transfer system, a traveling gear, a steering system, a braking system, an acceleration system, a suspension system, a transmission system, a fuel system, front, rear, left, and right wheels, etc. The vehicle may further include various safety systems for safety of the driver and passengers.

As an example of the braking system, a brake pedal 131 is equipped in the vehicle, and as an example of the acceleration system, an accelerator pedal 132 may be equipped in the vehicle.

The safety systems may include an airbag control unit for the purpose of the safety of driver and passengers in case of car crashes and an Electronic Stability Control (ESC) unit for stabilizing the vehicle's position while the vehicle 1 is accelerating or cornering.

In addition, the vehicle 1 may further include at least one detector, such as an approximation sensor device for detecting an obstacle or other vehicle approaching to the sides or behind, a rain sensor device for detecting whether it is raining and the amount of rainfall, a wheel speed sensor device for detecting the speed of the wheels of the vehicle 1, a lateral acceleration sensor device for detecting lateral acceleration of the vehicle 1, a yaw rate sensor device for detecting a change in angular velocity of the vehicle 1, a gyro sensor device, a steering angle sensor device for detecting turning of the steering wheel of the vehicle 1, etc.

The vehicle 1 includes an Electronic Control Unit (ECU) for controlling operation of the power generating system, power transfer system, traveling gear, steering system, braking system, suspension system, transmission system, fuel system, various safety systems and various sensor devices.

Furthermore, the vehicle 1 may optionally include electronic devices, such as a hands-free system, a GPS, an audio system and Bluetooth system, a rear camera, a charging system for a terminal, E-Z pass (hi-pass in Korea) equipment, etc.

The vehicle 1 may further include an engine start button to provide a command to operate a start motor (not shown).

Specifically, pushing the engine start button drives the start motor, which in turn drives the power generating system, i.e., an engine (not shown).

The vehicle 1 further includes a battery (not shown) electrically connected to the terminal, audio system, indoor lighting system, start motor, and other electronic devices for supplying power. The battery is charged using dynamic power of the internal generator or the engine while the vehicle is driven.

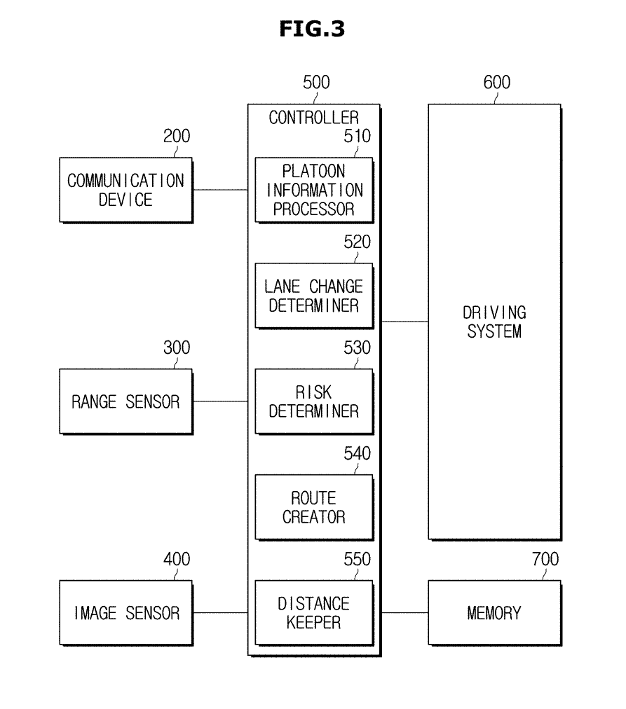

FIG. 3 is a control block diagram of a vehicle, according to an embodiment of the present disclosure.

Referring to FIG. 3, the vehicle 1 includes a communication device 200, the range sensor 300, the image sensor 400, the controller 500, a driving system 600, and a memory 700.

The communication device 200 transmits or receives data between vehicles. The vehicle 1 may exchange data with a plurality of vehicles grouped into a line with the vehicle 1 through the communication device 200. Data exchanged between vehicles may include acceleration, speed, and turn indicator operation information of each vehicle, a moving trajectory of a vehicle ahead, platoon information, and a moving trajectory of the platoon. The communication device 200 may be a Vehicle to Vehicle (V2V) communication device for forming a network between vehicles.

The communication device 200 may transmit or receive a message including event data when an event occurs or may transmit or receive a message including data periodically.

The range sensor 300 may collect data about an object around the vehicle 1. The range sensor 300 may measure a distance to an object by emitting a laser pulse signal and measuring arrival time of pulse signals reflected from objects within a measurement range. Furthermore, the range sensor 300 may measure spatial coordinates of an object and accordingly, may collect three-dimensional (3D) information of the object. The range sensor 300 scans the surface of an object in a way of sampling and outputs the sampled dot data. The range sensor 300 may also measure speed of an object around the vehicle 1.

The image sensor 400 may collect image data around the vehicle 1. The image sensor 400 may acquire an image of an object around the vehicle 1 by taking pictures of the surroundings of the vehicle 1. The image sensor 400 may acquire an image of another vehicle that exists in front or back, or on the side of the vehicle 1, and may detect a lane by acquiring an image of the road on which the vehicle 1 is moving.

Upon reception of a lane change signal from a vehicle ahead that forms a line with the vehicle 1 through the communication device 200, the controller 500 may determine whether there is a following vehicle based on the data collected by the range sensor 300 and the image sensor 400 and create a target lane if there is no following vehicle. The controller 500 may also determine a risk of lane change to the target lane.

The driving system 60 may drive the vehicle 1 by receiving control signals from the controller 500. In other words, the driving system 600 performs lane changing of the vehicle 1 by driving devices of the vehicle 1 upon reception of control signals. For example, the driving system 60 may receive control signals from the controller 500 to operate the turn indicator light 17, the steering wheel 124, the brake pedal 131, and the accelerator pedal 132.

The memory 700 stores data exchanged through the communication device 200 and data collected by the range sensor 300 and the image sensor 400.

Specifically, the controller 500 includes a platoon information processor 510, a lane change determiner 520, a risk determiner 530, a route creator 540, and a distance keeper 550.

The platoon information processor 510 extracts information about a platoon formed by a plurality of vehicles. The information about a platoon may include identifiers (IDs) allocated to the respective vehicles, the order of the plurality of vehicles, information about a moving trajectory of a vehicle ahead, and information about a moving trajectory of the platoon.

The platoon information processor 510 receives data about a vehicle that is moving ahead of the vehicle 1 and time at which the data is collected, from the range sensor 300. The platoon information processor 510 extracts relative coordinates of the vehicle ahead based on the received data, the time at which the data is collected, and the vehicle ID. In other words, each vehicle in the platoon extracts coordinates of a vehicle ahead using the range sensor 300. The relative coordinates is represented in Cartesian coordinate system.

The platoon information processor 510 may use the relative coordinates of the vehicle ahead to extract a moving trajectory of the vehicle ahead. Furthermore, the platoon information processor 510 may receive relative coordinates of a vehicle ahead from each vehicle of the platoon through the communication device 200 and reconfigure the relative coordinates of the vehicle ahead by reflecting current speeds, yaw-rate information, and communication delay errors of the vehicle ahead and the vehicle 1. The platoon information processor 510 may link the reconfigured relative coordinates to extract the moving trajectory of the platoon.

The lane change determiner 520 determines whether lane changing is required based on whether there is an obstacle ahead of the vehicle 1. In other words, the lane change determiner 520 determines that lane changing is required if an obstacle is detected from the road ahead of the vehicle 1 and sends a lane change signal. The lane change signal may correspond to a signal to activate a turn indicator light of the lane changing direction. The driving system 60 activates the turn indicator light by receiving a signal to turn on the turn indicator light.

All the plurality of vehicles that form the platoon may determine a situation to change lanes, but it is more efficient for only a lead vehicle to determine the situation to change lanes in the platoon in which vehicles are driven while keeping a short distance from another vehicle. Accordingly, in the following description, it is assumed that the lead vehicle sends the lane change signal.

Assuming that two vehicles form a platoon, a vehicle ahead corresponds to a lead vehicle, which determines the situation to change lanes and sends the lane change signal. The vehicle 1, which is a following vehicle or a tail vehicle in the platoon, receives the lane change signal through the communication device 200.

The risk determiner 530 receives data from the range sensor 300 and the image sensor 400 equipped in a vehicle ahead and the vehicle 1 to determine a risk of a lane change to the lane changing direction. Especially, the vehicle 1 determines whether there is a following vehicle.

If there is no vehicle following the vehicle 1 in the platoon, the vehicle 1 corresponds to a tail vehicle that is located in the end of the platoon. Furthermore, if there is no vehicle behind the tail vehicle in the target lane to move into, it may be determined that there is no risk of lane change.

Otherwise, if there is a following vehicle, the vehicle 1 sends a lane change signal to the following vehicle, which in turn determines whether there is a following vehicle.

The route creator 540 may create a target lane if there is no following vehicle. The route creator 540 creates the target lane based on a moving trajectory of the platoon, which is extracted by the platoon information processor 510 and the width of a lane detected by the image sensor 400. Lane changing is moving laterally by the lane width, so the target lane becomes the lane separated as far as the lane width from the moving trajectory of the platoon formed by the vehicle ahead and the vehicle 1.

Furthermore, the route creator 540 may create a lane changing route for the vehicle 1 to move to the target lane.

The risk determiner 530 re-determines a risk of lane change to the generated target lane. The risk determiner 530 may determine whether there is a vehicle driven in the target lane and, if there is no vehicle in the target lane, determine that there is no risk of lane change.

The risk determiner 530 may also determine that there is no risk of lane change if a vehicle is driven ahead outside the lane changing route to the target lane. Since the vehicle 1, which is the tail vehicle, is the first vehicle to perform lane changing, if a vehicle is driven ahead outside the lane changing route, the vehicle 1 may not have the risk of lane change.

The risk determiner 530 may also determine that there is no risk of lane change if there is no vehicle on the lane changing route for a predetermined lane changing time limit. For example, if the lane changing time limit is 5 seconds, there is a risk of lane change when there is a vehicle X1 on the lane changing route within 5 seconds after the lane changing route is created and there is no risk of lane change when there is no vehicle X1 on the lane changing route.

That is, even if there is a vehicle driven in the target lane, the vehicle 1, which is the tail vehicle, may be able to change lanes. In this case, the risk determiner 530 sends a slowdown signal to a vehicle ahead based on the speed of the vehicle in the target lane as soon as the vehicle 1 changes lanes.

Since the vehicle still is driven in the target lane even if the tale vehicle, the vehicle 1, has completed lane changing, the lead vehicle needs to slow down and perform lane changing after the vehicle passes by.

The distance keeper 550 keeps the distance between the vehicle 1 and the vehicle ahead constant after the vehicle 1 performs lane changing.

Detailed blocks that constitute the controller 500 were described, but the functions performed by the blocks may also be mentioned as being performed by the controller 500.

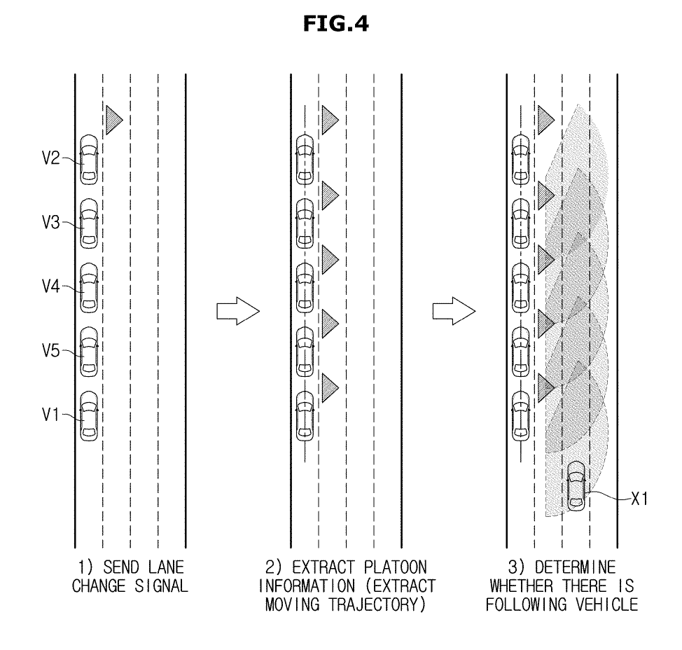

A vehicle V1 shown in FIGS. 4 to 8 is the same as the aforementioned vehicle 1, but is denoted herein with a different reference numeral for convenience.

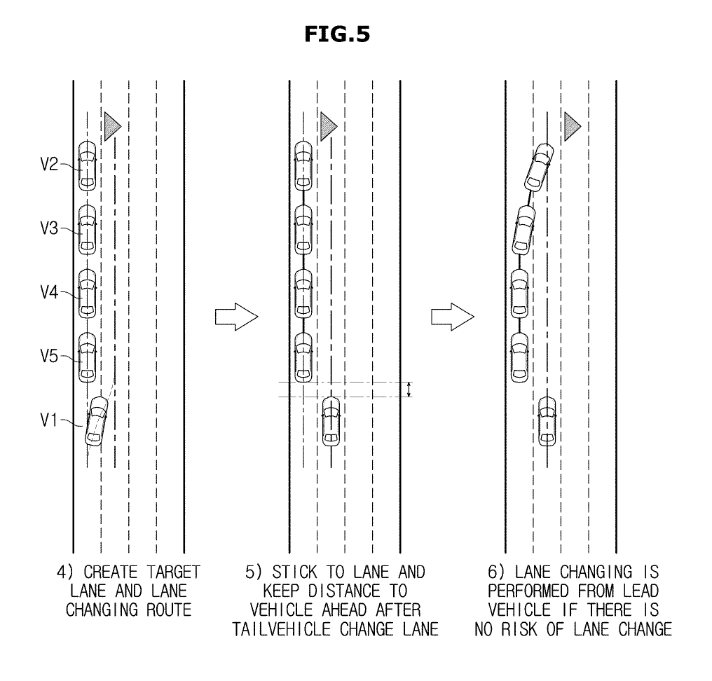

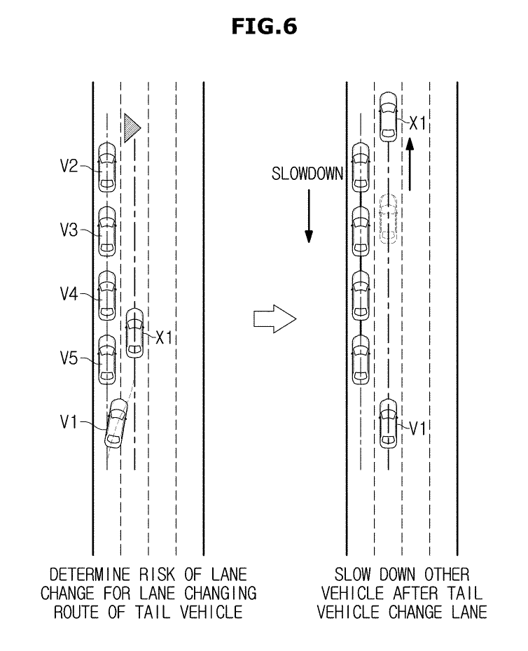

FIGS. 4 and 5 are views for explaining how the vehicle 1 changes lanes, according to an embodiment of the present disclosure, and FIG. 6 is a view for explaining how a vehicle changes lanes when there is a vehicle in a target lane to move to, according to an embodiment of the present disclosure.

FIGS. 4 to 6 show vehicle platooning, in which a plurality of vehicles V1, V2, V3, V4, and V5 form a platoon. The number of the vehicles that form the platoon is only by way of example to help understanding, and it is not necessary to include the intermediate vehicles V3, V4, and V5 in the platoon. Accordingly, the following description will focus on the vehicle 1 and a lead vehicle V2.

Referring to FIG. 4, the vehicle V1 receives a lane change signal from the lead vehicle V2. If the intermediate vehicles V3, V4, and V5 exist, they forward the lane change signal sent by the lead vehicle V2 to the vehicle V1.

Each vehicle in the platoon extracts the platoon information and sends or receives it. Especially, each vehicle extracts information about a moving trajectory of a vehicle ahead.

The vehicle V1 receives the lane change signal and determines whether there is a vehicle behind in the platoon. If there is no vehicle behind, the vehicle V1 determines itself as a tail vehicle and extracts moving trajectory information of the platoon. The moving trajectory of the platoon is extracted by summing up the respective moving trajectory information of vehicles ahead that the respective vehicles in the platoon extract. How to extract a moving trajectory of the platoon was described above, so the description thereof will not be repeated.

Referring to FIG. 5, the tale vehicle, vehicle V1, creates a target lane based on an extracted moving trajectory of a platoon and the lane width. The vehicle V1 may create a lane changing route to the target lane.

The vehicle V1 determines whether there is a risk of lane change by determining whether there is a vehicle X1 driven on the target lane. In FIG. 5, there is no other vehicle X1 in the target lane created by the vehicle V1, so it is determined that there is no risk of lane change.

The vehicle V1 performs lane changing to the target lane along the lane changing route. After completion of lane changing, the vehicle V1 sends a lane change completion signal to the lead vehicle V2 and keeps a distance to a vehicle ahead.

After completion of lane changing of the tale vehicle, vehicle V1, the lead vehicle V2 performs lane changing. The intermediate vehicle V3 performs lane changing by following the lane changing route of the lead vehicle V2, and the intermediate vehicle V4 performs lane changing by following the route of the vehicle V3 ahead. The intermediate vehicle V5 also changes lanes by following the route of the vehicle V4 ahead.

Referring to FIG. 6, there exists a vehicle X1 driven in the target lane created by the tale vehicle, vehicle V1. In this case, the vehicle V1 determines that there is a risk of lane change.

However, even if there exists the vehicle X1 on the target lane, it may be determined that there is no risk of lane change if the vehicle X1 is driven ahead outside the lane changing route of the vehicle V1. The vehicle V1 determines that there is no risk of lane change if there is no vehicle X1 on the lane changing route for a predetermined lane changing time limit and then performs lane changing.

After completion of lane changing, the vehicle V1 extracts the speed of the vehicle X1 and sends a slowdown signal to the lead vehicle V2 based on the speed of the vehicle X1. The lead vehicle V2 performs slowing down according to the slowdown signal and performs lane changing after the vehicle X1 goes ahead.

How the intermediate vehicles V3, V4, and V5 change lanes are the same as what is described above in connection with FIG. 5.

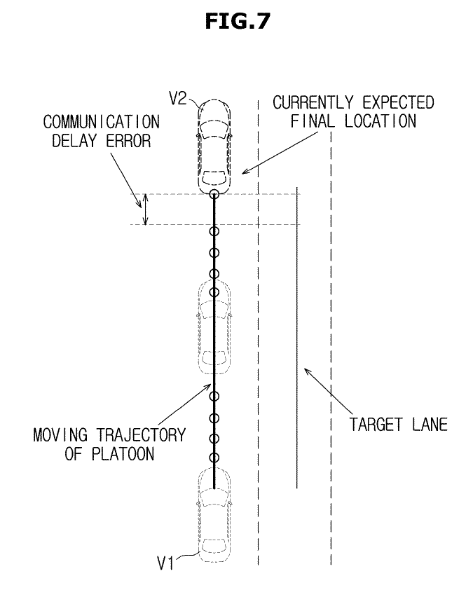

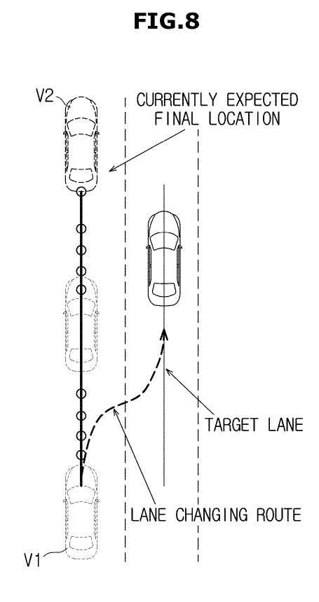

FIG. 7 is a view for explaining how a vehicle creates a target lane, according to an embodiment of the present disclosure, and FIG. 8 is a view for explaining how a vehicle creates a lane changing route, according to an embodiment of the present disclosure.

Referring to FIG. 7, the vehicle V1 may receive relative coordinates of a vehicle ahead from each vehicle of the platoon through the communication device 2000 and reconfigure the relative coordinates of the vehicle ahead by reflecting current speeds, yaw-rate information, and communication delay errors of the vehicle ahead and the vehicle V1. The vehicle V1 may link the reconfigured relative coordinates to extract the moving trajectory of the platoon.

The vehicle V1 creates a target lane based on the extracted moving trajectory of the platoon and the width of a lane detected by the image sensor 400.

Referring to FIG. 8, the vehicle V1 may create a lane changing route to the target lane. The controller 500 of the vehicle V1 determines that there is no risk of lane change if there is no vehicle on the lane changing route for a predetermined lane changing time limit.

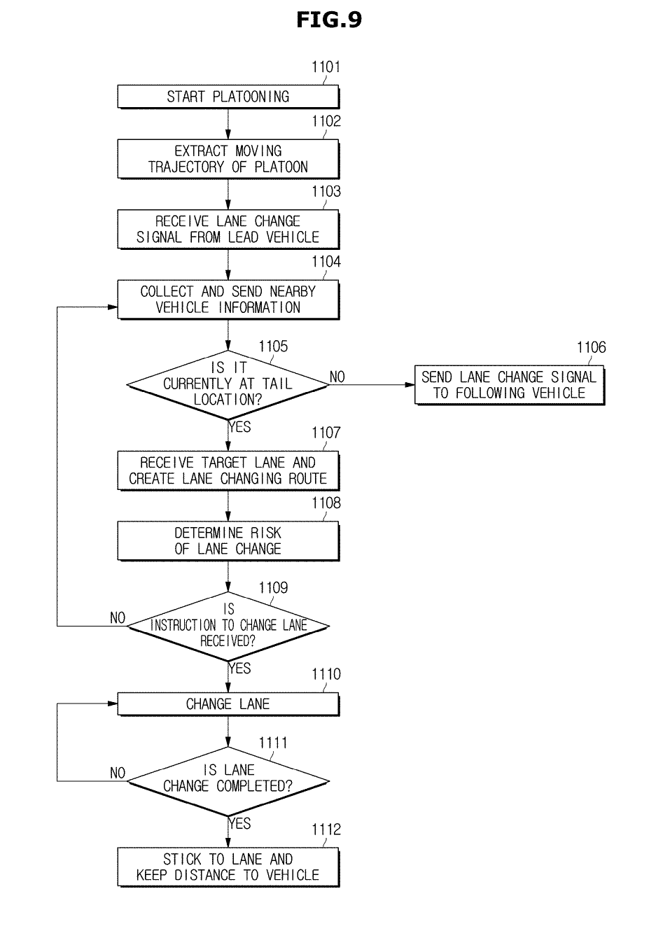

FIG. 9 is a flowchart illustrating a control method of the vehicle 1, according to an embodiment of the present disclosure.

Referring to FIG. 9, once platooning is started in 1101, the vehicle 1 collects platoon information from a vehicle ahead in the platoon and extracts a moving trajectory of the platoon in 1102. When the vehicle 1 receives a lane change signal from the vehicle ahead in 1103, the vehicle 1 collects information about an object around the vehicle 1 from the range sensor 300 and the image sensor 400 and sends the collected information to other vehicle in 1104.

The controller 500 of the vehicle 1 determines whether the vehicle 1 is located at the end based on the collected information, in 1105. In other words, the vehicle 1 determines whether there is a following vehicle. If there exists a following vehicle, the vehicle 1 forwards the lane change signal to the following vehicle, in 1106. If there is no following vehicle, the vehicle 1 determines itself as a tail vehicle and creates a target lane, in 1107. The vehicle V1 may create a lane changing route after creating the target lane.

Subsequently, the vehicle 1 determines a risk of lane change to the target lane, in 1108. If it is determined that there is no risk of lane change, the vehicle 1 performs lane changing, in 1110. Although it is shown that the vehicle 1 receives an instruction from a vehicle ahead to perform lane changing in 110g, the instruction from the vehicle ahead is not necessarily required.

The vehicle 1 determines whether the lane changing is completed in 1111, and keeps a distance to the vehicle ahead and sticks to the lane in 1112 if the lane changing is completed.

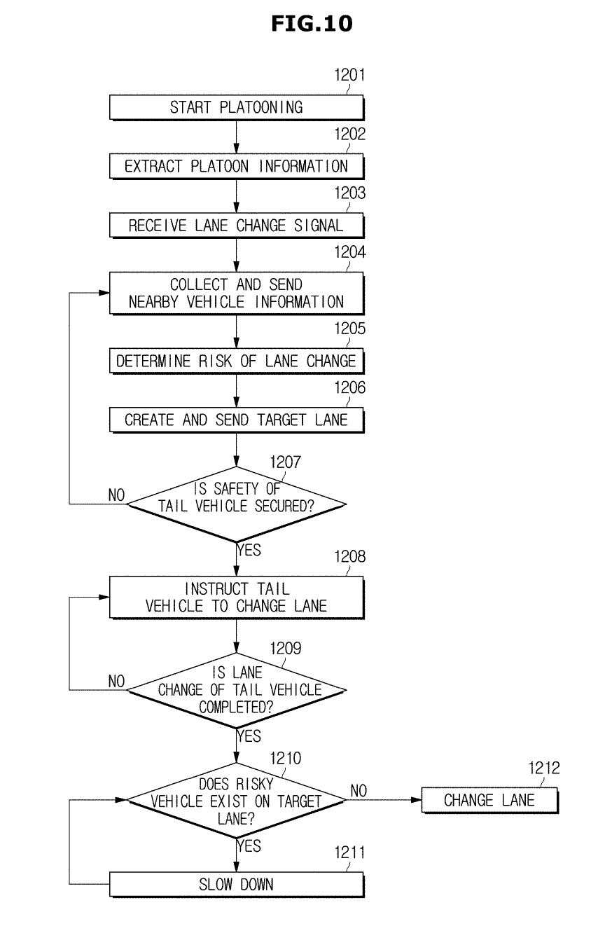

FIG. 10 is a flowchart illustrating how to control a lead vehicle in a method for controlling vehicles driven in a platoon, according to an embodiment of the present disclosure.

Referring to FIG. 10, once platooning is started in 1201, the lead vehicle V2 receives data from the respective vehicles that form the platoon to extract platoon information in 1202. The platoon information was described above, so the description thereof will not be repeated.

If an obstacle is detected from ahead, the lead vehicle V2 determines that lane changing is required and sends a lane change signal to a following vehicle in 1203 and simultaneously, collects and sends information about nearby vehicles in 1204.

The lead vehicle V2 receives information about a risk of lane change from the tail vehicle, and if determining that there is no risk of the tail vehicle in changing lanes in 1205, instructs the tail vehicle to perform lane changing in 1206. If the lead vehicle V2 receives a lane change completion signal from the tail vehicle in 1207, it determines whether there exists a risky vehicle on the target lane in 1208. In other words, the lead vehicle V2 may determine whether there exists a vehicle X1 on the target lane.

If the vehicle X1 exists on the target lane and the vehicle X1 is moving behind the lead vehicle V2, the lead vehicle V2 slows down, in 1209. If there is no vehicle X1 on the target lane, the lead vehicle V2 performs lane changing, in 1210.

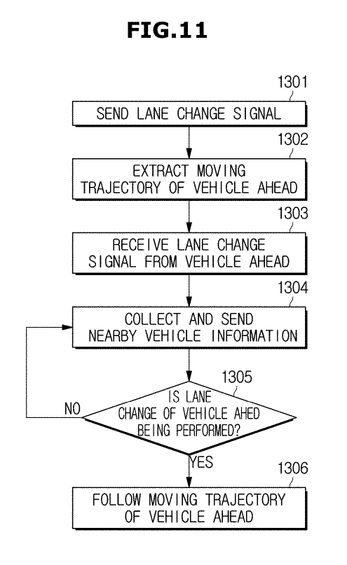

FIG. 11 is a flowchart illustrating how to control an intermediate vehicle in a method for controlling vehicles driven in a platoon, according to an embodiment of the present disclosure; and

Referring to FIG. 11, once platooning is started in 1301, the intermediate vehicles V3, V4, and V5 each extract a moving trajectory of a vehicle ahead, in 1302. How to extract a moving trajectory of a vehicle ahead was described above, so the description thereof will not be repeated.

The intermediate vehicles V3, V4, and V5 each receive a lane change signal from a vehicle ahead in 1303 and collect and send information about a nearby vehicle using the range sensor and image sensor equipped in the vehicle in 1304.

If the vehicle ahead changes lanes in 1305, the intermediate vehicles V3, V4, and V5 each make a lane change by following a moving trajectory of the vehicle ahead in 1306.

As described above, a vehicle and control method thereof in accordance with an embodiment of the present disclosure allows a vehicle driven in a platoon to stably change lanes.

Specifically, the vehicle and control method thereof allows a tail vehicle that runs at the end of the platoon to first perform lane changing to a target lane, enabling stable lane changing of the entire vehicles of the platoon, if a lead vehicle of the platoon determines a situation to change lanes and sends a lane change signal.

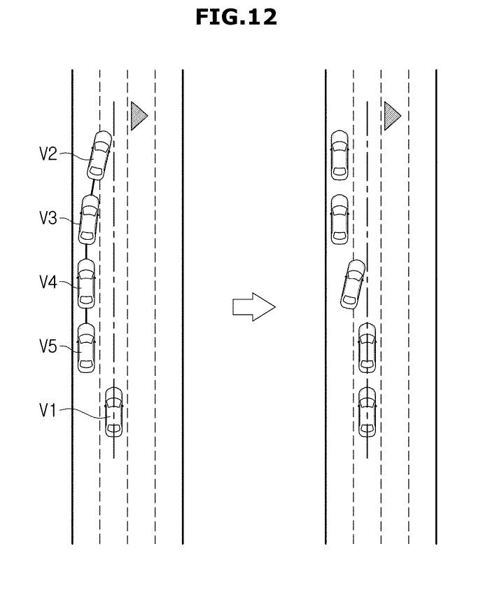

FIG. 12 is a view for explaining how a vehicle driven in a platoon changes lanes, according to another embodiment of the present disclosure.

Referring to FIG. 12, after the tail vehicle V1 completes lane changing, lane changing is performed by not the lead vehicle V2 first but a vehicle ahead of the tail vehicle V1 first in reverse order.

The platoon information is collected from all of the plurality of vehicles that form the platoon, and each vehicle in the platoon may extract a moving trajectory of the platoon.

Configurations for the lead vehicle V2 to determine a situation to change lanes and send a lane change signal, to create a target lane and a lane changing route, and to determine a risk of lane change are the same as what are described above.

Meanwhile, the embodiments of the present disclosure may be implemented in the form of recording media for storing instructions to be carried out by a computer. The instructions may be stored in the form of program codes, and when executed by a processor, may generate program modules to perform operation in the embodiments of the present disclosure. The recording media may correspond to computer-readable recording media.

The computer-readable recording medium includes any type of recording medium having data stored thereon that may be thereafter read by a computer. For example, it may be a ROM, a RAM, a magnetic tape, a magnetic disk, a flash memory, an optical data storage device, etc.

According to embodiments of the present disclosure, a vehicle driven in a platoon may be able to stably change lanes.

Specifically, if a vehicle ahead in the platoon determines a situation of a lane change and sends a lane change signal, a tail vehicle that runs at the end of the platoon first performs lane changing to a target lane, thereby enabling the entire vehicles in the platoon to stably change lanes.

Several embodiments have been described above, but a person of ordinary skill in the art will understand and appreciate that various modifications can be made without departing the scope of the present disclosure. Thus, it will be apparent to those ordinary skilled in the art that the true scope of technical protection is only defined by the following claims.

What is claimed is:

1. A vehicle comprising:
a range sensor configured to collect data about an object around the vehicle;
an image sensor configured to collect image data around the vehicle;
a communication device configured to transmit or receive data the vehicle and another vehicle;
a controller configured to, upon reception of a lane change signal from a vehicle ahead in a platoon formed by the vehicle and the vehicle ahead through the communication device, determine whether there is a following vehicle based on the data collected by the range sensor and the image sensor, to create a target lane when there is no following vehicle, and to determine a risk of lane change; and
a driving system configured to drive the vehicle based on a control signal from the controller.

2. The vehicle of claim 1, wherein the controller is configured to extract a moving trajectory of the platoon formed by the vehicle and the vehicle ahead, and to create a target lane based on the moving trajectory of the platoon and a lane width.

3. The vehicle of claim 2, wherein the controller is configured to receive relative coordinates of the vehicle ahead from the range sensor periodically, to reconfigure the relative coordinates by reflecting current speeds, yaw-rate information and communication delay errors of the vehicle and the vehicle ahead, and to link the reconfigured relative coordinates to extract a moving trajectory of the platoon.

4. The vehicle of claim 1, wherein the controller is configured to determine the risk of lane change based on whether there exists a vehicle driven on the target lane.

5. The vehicle of claim 4, wherein the controller is configured to create a lane changing route to the target lane and to determine that there is no risk of lane change when the vehicle driven on the target lane is driven ahead outside the lane changing route.

6. The vehicle of claim 5, wherein the controller is configured to determine that there is no risk of lane change when there is no vehicle on the lane changing route for a predetermined lane changing time limit.

7. The vehicle of claim 5, wherein the controller is configured to send a slowdown signal to the vehicle ahead based on speed of the vehicle driven on the target lane.

8. The vehicle of claim 1, wherein the controller is configured to send a lane change complete signal to the vehicle ahead when the lane changing is completed.

9. The vehicle of claim 1, wherein the controller is configured to forward the lane change signal to a following vehicle.

10. A control method for a vehicle, the method comprising:
collecting data about an object around the vehicle;
collecting image data around the vehicle;
receiving a lane change signal from a vehicle ahead in a platoon formed by the vehicle and the vehicle ahead;
determining whether there exists a following vehicle based on image data and data about an object around the vehicle;
creating a target lane when there is no following vehicle;
determining a risk of lane change to the target lane; and
performing lane changing to the target lane when there is no risk of lane change.

11. The method of claim 10, wherein the creating of the target lane comprises:
extracting a moving trajectory of the platoon formed by the vehicle and the vehicle ahead; and
creating a target lane based on the moving trajectory of the platoon and lane width.

12. The method of claim 11, wherein extracting the moving trajectory of the platoon comprises:
periodically receiving relative coordinates of the vehicle ahead;
reconfiguring the relative coordinates by reflecting current speeds, yaw-rate information and communication delay errors of the vehicle and the vehicle ahead; and
linking the reconfigured relative coordinates to extract a moving trajectory of the platoon.

13. The method of claim 10, wherein the determining of the risk of lane change comprises determining the risk of lane change based on whether there exists a vehicle driven on the target lane.

14. The method of claim 13, further comprising creating a lane changing route to the target lane, wherein the determining of the risk of lane change comprises determining that there is no risk of lane change when the vehicle driven on the target lane is driven ahead outside the lane changing route.

15. The method of claim 14, wherein the determining of the risk of lane change comprises determining that there is no risk of lane change when there is no vehicle on the lane changing route for a predetermined lane changing time limit.

16. The method of claim 14, further comprising sending a slowdown signal to the vehicle ahead based on a speed of the vehicle driven on the target lane.

17. The method of claim 10, further comprising sending a lane change complete signal to the vehicle ahead when the lane changing is completed.

18. The method of claim 10, wherein determining of whether there exists a following vehicle comprises determining that there exists a following vehicle, the method further comprising forwarding the lane change signal to a following vehicle when there exists the following vehicle.

19. A control method for vehicles driven in a platoon, the method comprising:
collecting platoon information and information about nearby objects, the collecting being performed by each of the vehicles that form the platoon;
determining, by a lead vehicle in the platoon, a situation to change lanes based on the information about the nearby objects;
sending, by the lead vehicle in the platoon, a lane change signal to an intermediate vehicle in the platoon;
determining, by a following vehicle, that the following vehicle corresponds to a tail vehicle in the platoon, the following vehicle being a vehicle following the lead vehicle and one or more intermediate vehicles;
creating, by the tail vehicle, a target lane;
determining, by the tail vehicle, a risk of lane change to the target lane; and
performing, by the tail vehicle, lane changing to the target lane when there is no risk of lane change.

20. The method of claim 19, further comprising:
sending, by the tail vehicle, a lane change completion signal to the lead vehicle after changing lanes; and
performing, by the lead vehicle, lane changing to the target lane.

21. The method of claim 20, further comprising changing lanes, by the intermediate vehicle, by following a lane changing route of the lead vehicle after the lead vehicle changes lanes.
